(19) United States
(12) Patent Application Publication
(10) Pub. No.: US 2009/0074584 A1
(43) Pub. Date: Mar. 19, 2009

(54) NICKEL-BASED ALLOY FOR TURBINE ROTOR OF STEAM TURBINE AND TURBINE ROTOR OF STEAM TURBINE

(75) Inventors: Kuniyoshi Nemoto, Kawasaki-shi (JP); Kiyoshi Imai, Taito-ku (JP); Yomei Yoshioka, Yokohama-shi (JP); Masayuki Yamada, Yokohama-shi (JP); Reki Takaku, Yokohama-shi (JP); Takeo Suga, Yokohama-shi (JP); Masafumi Fukuda, Saitama-shi (JP); Kenichi Okuno, Yokohama-shi (JP); Akihiro Takakuwa, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/210,475

(22) Filed: Sep. 15, 2008

(30) Foreign Application Priority Data
Sep. 14, 2007 (JP) 2007-239227

(51) Int. Cl. B64C 27/46; C22C 19/05

(52) U.S. Cl. 416/223 R; 420/448

(57) ABSTRACT

A Nickel-based alloy for a turbine rotor of a steam turbine contains C: 0.01 to 0.15, Cr: 18 to 28, Co: 10 to 15, Mo: 8 to 12, Al: 1.5 to 2, Ti: 0.1 to 0.6, B: 0.001 to 0.006, Ta: 0.1 to 0.7 in % by weight, and the remaining portion is composed of Ni and unavoidable impurities. The Nickel-based alloy is composed of the above-stated chemical composition range, and thereby, a mechanical strength improves while maintaining forgeability as same as a conventional steel.

### CROSS-REFERENCE TO RELATED APPLICATIONS

This application is based upon and claims the benefit of priority from the prior Japanese Patent Application No. 2007-239227, filed on Sep. 14, 2007; the entire contents of which are incorporated herein by reference.

### BACKGROUND

1. Field of the Invention

The present invention relates to a material constituting a turbine rotor of a steam turbine in which high-temperature steam flows in as a working fluid, and in particular to an Nickel-based alloy for the turbine rotor of the steam turbine which excels in high-temperature strength and so on, and to the turbine rotor of the steam turbine constituted by the Nickel-based alloy.

2. Description of the Related Art

In a thermal power plant including a steam turbine, an art to suppress carbon dioxide emissions attracts attention from a point of view of global environmental protection, and needs for high-efficiency of power generation increase.

It is effective to make turbine steam temperature high to increase the power generation efficiency of the steam turbine, and the steam temperature increases up to 600° C. or more in a thermal power generation plant including a recent steam turbine. There is a tendency to increase up to 650° C., further 700° C. in the future.

In a turbine rotor supporting a rotor blade rotating by receiving the high-temperature steam, high-temperature steam turns over a periphery thereof to be high temperature, and high stress occurs by the rotation. Accordingly, it is necessary for the turbine rotor to resist the high-temperature and high-stress, and a material having good strength, ductility and toughness in a region from room temperature to high-temperature is required as the material constituting the turbine rotor.

In particular, when the steam temperature is over 700° C., for example, an application of an Nickel-based alloy is studied in JP-A 7-150277(KOKAI), because a conventional iron-based material falls short of the high-temperature strength.

The Nickel-based alloy has been widely applied mainly as materials of a jet engine and a gas turbine because it excels in the high-temperature strength and a corrosion resistance. Inconel 617 alloy (manufactured by Special Metal Corporation) and Inconel 706 alloy (manufactured by Special Metal Corporation) are used as representative examples.

As a mechanism strengthening the high-temperature strength of the Nickel-based alloy, there is the one in which a precipitation phase called as a gamma prime phase (Ni₃(Al, Ti)) or a gamma double prime phase is formed in a parent phase material of the Nickel-based alloy by adding Al or Ti, and the high-temperature strength is secured by precipitating the above-stated both phases. For example, Inconel 706 alloy can be cited as the material securing the high-temperature strength by precipitating the both phases of the gamma prime phase and the gamma double prime phase.

On the other hand, there also is the one in which the high-temperature strength is secured by strengthening (solid-solution strength) the parent phase of the Nickel-base by adding Co, Mo such as Inconel 617 alloy.

As stated above, the application of the Nickel-based alloy is studied as the material of the turbine rotor of the steam turbine of which temperature is over 700° C., but it is conceivable that there is room for further improvement of the high-temperature strength. Besides, the high-temperature strength of the Nickel-based alloy is required to be improved by a composition improvement and so on while maintaining forgeability, a welding property, and so on of the Nickel-based alloy.

### BRIEF SUMMARY OF THE INVENTION

Accordingly, an object of the present invention is to provide an Nickel-based alloy for a turbine rotor of a steam turbine capable of improving mechanical strength while maintaining workability such as forgeability, and the turbine rotor of the steam turbine constituted by the Nickel-based alloy.

According to an aspect of the present invention, an Nickel-based alloy for a turbine rotor of a steam turbine containing: C: 0.01 to 0.15; Cr: 18 to 28; Co: 10 to 15; Mo: 8 to 12; Al: 1.5 to 2; Ti: 0.1 to 0.6; B: 0.001 to 0.006; Ta: 0.1 to 0.7 in % by weight, and whose remaining portion is composed of Ni and unavoidable impurities is provided.

Besides, according to another aspect of the present invention, an Nickel-based alloy for a turbine rotor of a steam turbine containing: C: 0.01 to 0.15; Cr: 18 to 28; Co: 10 to 15; Mo: 8 to 12; Al: 1.5 to 2; Ti: 0.1 to 0.6; B: 0.001 to 0.006; Nb: 0.1 to 0.4 in % by weight, and whose remaining portion is composed of Ni and unavoidable impurities is provided.

Further, according to still another aspect of the present invention, an Nickel-based alloy for a turbine rotor of a steam turbine containing: C: 0.01 to 0.15; Cr: 18 to 28; Co: 10 to 15; Mo: 8 to 12; Al: 1.5 to 2; Ti: 0.1 to 0.6; B: 0.001 to 0.006; Ta+2Nb: 0.1 to 0.7 in % by weight, and whose remaining portion is composed of Ni and unavoidable impurities is provided.

Besides, according to still another aspect of the present invention, a turbine rotor of a steam turbine provided through the steam turbine to which high-temperature steam is inlet, wherein at least a predetermined portion is constituted by the above-stated Nickel-based alloy for the turbine rotor of the steam turbine is provided.

### BRIEF DESCRIPTION OF THE DRAWINGS

The present invention will be described with reference to the drawings, but these drawings are provided only for an illustrative purpose and by no means are intended to limit the present invention.

FIG. 1 is a view showing results of a Greeble test in respective samples.

### DETAILED DESCRIPTION OF THE INVENTION

Hereinafter, an embodiment of the present invention is described.

A Nickel-based alloy according to an embodiment of the present invention is composed of a composition component range shown in the following. Incidentally, “%” representing a composition component in the following description means “% by weight” unless it is particularly specified.

(M1) A Nickel-based alloy containing C: 0.01% to 0.15%, Cr: 18% to 28%, Co: 10% to 15%, Mo: 8% to 12%, Al: 1.5% to 2%, Ti: 0.1% to 0.6%, B: 0.001% to 0.006%, Ta: 0.1% to 0.7%, and whose remaining portion is composed of Ni and unavoidable impurities.

(M2) A Nickel-based alloy containing C: 0.01% to 0.15%, Cr: 18% to 28%, Co: 10% to 15%, Mo: 8% to 12%, Al: 1.5% to 2%, Ti: 0.1% to 0.6%,B: 0.001% to 0.006%, Nb: 0.1% to 0.4%, and whose remaining portion is composed of Ni and unavoidable impurities.

(M3) A Nickel-based alloy containing C: 0.01% to 0.15%, Cr: 18% to 28%, Co: 10% to 15%, Mo: 8% to 12%, Al: 1.5% to 2%, Ti: 0.1% to 0.6%, B: 0.001% to 0.006%, Ta+2Nb: 0.1% to 0.7%, and whose remaining portion is composed of Ni and unavoidable impurities.

Here, in the unavoidable impurities in the Nickel-based alloys of the above-stated (M1) to (M3), it is preferable that at least Si is suppressed to be 0.1% or less and Mn is suppressed to be 0.1% or less among the unavoidable impurities.

The Nickel-based alloy within the above-stated composition component range is suitable as a material constituting a turbine rotor of a steam turbine of which temperature in operation time reaches 680° C. to 750° C. Here, every portion of the turbine rotor of the steam turbine may be constituted by this Nickel-based alloy, or a part of the portions of the turbine rotor of the steam turbine which reaches high temperature in particular may be constituted by this Nickel-based alloy. Here, more specifically, every region of a high pressure steam turbine portion, a region from the high pressure steam turbine portion to a part of an intermediate pressure steam turbine portion, or the like can be cited as the part of the turbine rotor of the steam turbine reaching the high temperature.

Besides, the Nickel-based alloy within the above-stated composition component range can improve mechanical strength including the high-temperature strength while maintaining a workability such as forgeability in a conventional Nickel-based alloy. Namely, the turbine rotor of the steam turbine is constituted by using this Nickel-based alloy, and thereby, it is possible to improve the high-temperature strength of the turbine rotor, and to manufacture the turbine rotor with high reliability even under a high-temperature environment. Besides, when the turbine rotor of the steam turbine is manufactured, it is possible to maintain the workability of the conventional Nickel-based alloy.

Next, reasons for limiting each composition component range in the above-stated Nickel-based alloy according to the present invention are described.

### (1) C (Carbon)

C is useful as a constitutional element of M₂₃C₆ type carbide being a strengthened phase, and it is one of factors of maintaining creep strength of an alloy to precipitate the M₂₃C₆ type carbide during the operation time of the steam turbine particularly under the high-temperature environment at the temperature of 650° C. or more. Besides, there also is an effect to secure fluidity of a molten metal at the time of casting. When a content ratio of C is less than 0.01%, an enough precipitation amount of the carbide cannot be secured, and the fluidity of the molten metal at the time of casting decreases remarkably. On the other hand, when the content ratio of C is over 0.15%, a component segregation trend when a large ingot is manufactured increases and a generation of M₆C type carbide being an embrittlement phase is accelerated. Accordingly, the content ratio of C is set to be 0.01% to 0.15%.

### (2) Cr (Chromium)

Cr is an essential element to enhance an oxidation resistance, a corrosion resistance and the mechanical strength of the Nickel-based alloy. Further, it is essential as a constitutional element of the M₂₃C₆ type carbide, and in particular, the creep strength of the alloy is maintained by precipitating the M₂₃C₆ type carbide during the operation time of the steam turbine under the high-temperature environment at 650° C. or more. Besides, Cr increases the oxidation resistance under a high-temperature steam environment. When a content ratio of Cr is less than 18%, the oxidation resistance decreases. On the other hand, when the content ratio of Cr is over 28%, a coarse trend is enhanced by remarkably accelerating the precipitation of the M₂₃C₆ type carbide. Accordingly, the content ratio of Cr is set to be 18% to 28%.

### (3) Co (Cobalt)

Co strengthens the parent phase by solid-solving in the parent phase in the Nickel-based alloy. However, when a content ratio of Co is over 15%, an intermetallic compound phase decreasing the mechanical strength is generated, and forgeability decreases. On the other hand, when the content ratio of Co is less than 10%, the workability decreases, and further, the mechanical strength decreases. Accordingly, the content ratio of Co is set to be 10% to 15%.

### (4) Mo (Molybdenum)

Mo has an effect to enhance the strength of the parent phase by solid-solving in the Ni parent phase. Besides, a part of Mo is replaced in the M₂₃C₆ type carbide, and thereby, a safety factor of the carbide is enhanced. When a content ratio of Mo is less than 8%, the above-stated effect is not shown, and when the content ratio of Mo is over 12%, the component segregation trend when the large ingot is manufactured increases and the generation of M₆C type carbide being the embrittlement phase is accelerated. Accordingly, the content ratio of Mo is set to be 8% to 12%.

### (5) Al (Aluminum)

Al generates a γ′ (gamma prime: Ni₃Al) phase together with Ni, and improves the mechanical strength of the Nickel-based alloy by the precipitation. When a content ratio of Al is less than 1.5%, both the mechanical strength and the forgeability are not improved compared to a conventional steel, and when the content ratio of Al is over 2%, the mechanical strength improves, but the forgeability decreases. Accordingly, the content ratio of Al is set to be 1.5% to 2%.

### (6) Ti (Titanium)

Ti generates the γ′ (gamma prime: Ni₃Al) phase together with Ni as same as Al, and improves the mechanical strength of the Nickel-based alloy. When a content ratio of Ti is less than 0.1%, the above-stated effect is not shown, and when the content ratio of Ti is over 0.6%, hot working property and the forgeability decreases, and further, notch sensitivity increases. Accordingly, the content ratio of Ti is set to be 0.1% to 0.6%.

### (7) B (Boron)

B has an effect to enhance the strength of the parent phase by precipitating in the Ni parent phase. When a content ratio of B is less than 0.001%, the above-stated effect is not shown, and when the content ratio of B is over 0.006%, there is a possibility of incurring grain boundary embrittlement. Accordingly, the content ratio of B is set to be 0.001% to 0.006%

### (8) Ta (Tantalum)

Ta is solid-solved in the γ′ (gamma prime: Ni₃Al) phase, enhances the strength, and stabilizes precipitation strength. When a content ratio of Ta is less than 0.1%, improvement is not seen in the above-stated effects compared to the conventional steel, and when the content ratio of Ta is over 0.7%, the mechanical strength is generally improved, but the forgeability decreases. Accordingly, the content ratio of Ta is set to be 0.1% to 0.7%.

### (9) Nb (Niobium)

Nb is solid-solved in the γ′ (gamma prime: Ni₃Al) phase, enhances the strength, and stabilizes the precipitation strength as same as Ta. When a content ratio of Nb is less than 0.1%, improvement is not seen in the above-stated effects compared to the conventional steel, and when the content ratio of Nb is over 0.4%, the mechanical strength is generally improved, but the forgeability decreases. Accordingly, the content ratio of Nb is set to be 0.1% to 0.4%.

Besides, both of the above-stated Ta and Nb are contained, and (Ta+2Nb) whose content ratio is within a range of 0.1% to 0.7% is contained, and thereby, they are solid-solved in the γ′ (gamma prime: Ni₃Al) phase, enhance the strength, and stabilize the precipitation strength. When the content ratio of (Ta+2Nb) is less than 0.1%, improvement is not seen in the above-stated effects compared to the conventional steel, and when the content ratio of (Ta+2Nb) is over 0.7%, the mechanical strength improves, but the forgeability decreases. Incidentally, in this case, Ta and Nb are respectively contained at least 0.01% or more. A specific gravity of Nb is approximately a half of Ta (a specific gravity of Ta: 16.6, the specific gravity of Nb: 8.57), and therefore, it is possible to increase a solid-solution amount by compositely adding Ta and Nb compared to a case when Ta is added independently. Besides, Ta is a strategic material, and therefore, material procurement is unstable. However, reserves of Nb are approximately 100 times of Ta, and a stable supply is possible. A melting point of Ta is higher than Nb (the melting point of Ta: approximately 3000° C., a melting point of Nb: approximately 2470° C.), and therefore, the γ′ phase at higher temperature is strengthened, and Ta excels in the oxidation resistance more than Nb.

### (10) Si (Silicon) and Mn (Manganese)

Si and Mn are classified into the unavoidable impurities in the Nickel-based alloy according to the present invention. Accordingly, it is desirable to approximate the remaining content ratio to 0% (zero) as much as possible.

Si is added to compensate for the corrosion resistance in case of an ordinary steel. However, the Cr content ratio in the Nickel-based alloy is large, and the corrosion resistance can be fully secured. Accordingly, Si remaining content ratio is set to be 0.1% or less, and it is desirable to approximate the remaining content ratio to 0% (zero) as much as possible, in the Nickel-based alloy according to the present invention.

Mn turns S (Sulfur) being a cause of the brittleness into MnS, and prevents the brittleness in case of the ordinary steel. However, a content ratio of S in the Nickel-based alloy is extremely small, and therefore, it is not necessary to add Mn. Accordingly, Mn remaining content ratio is set to be 0.1% or less, and it is desirable to approximate the remaining content ratio to 0% (zero) as much as possible, in the Nickel-based alloy according to the present invention.

A soaking process, a forging and a solution treatment are performed for an ingot obtained by melting the composition components composing the Nickel-based alloy in a vacuum induction melting furnace, and thereby, the above-stated Nickel-based alloy according to the present invention is manufactured.

It is preferable that the ingot is kept at a temperature range from 1050° C. to 1075° C. for five to six hours in the soaking process, and kept at a temperature range from 1100° C. to 1180° C. for four to five hours in the solution treatment. Here, the solution treatment is performed to solid-solve the γ′ phase precipitates homogeneously. The γ′ phase precipitates are not fully solid-solved at the temperature lower than 1100° C., and the strength is lowered at the temperature higher than 1180° C. because crystal grains are coarsened. Besides, the forging is performed at a temperature range from 950° C. to 1100° C. (reheat temperature is 1100° C.).

Besides, when a turbine rotor of a steam turbine is constituted by the above-stated Nickel-based alloy according to the present invention, for example, raw materials are performed a vacuum induction melting (VIM), an electroslag remelting (ESR), and they are poured into a predetermined mold, as one method (double melt). Subsequently, a forging process, a heat treatment are performed to manufacture the turbine rotor. As another method (double melt), the raw materials are performed the vacuum induction melting (VIM), a vacuum arc remelting (VAR), and it is poured into the predetermined mold. Subsequently, the forging process, the heat treatment are performed to manufacture the turbine rotor. Further, as the other method (triple melt), the raw materials are performed the vacuum induction melting (VIM), the electroslag remelting (ESR), the vacuum arc remelting (VAR), and they are poured into the predetermined mold. Subsequently, the forging process, the heat treatment are performed to manufacture the turbine rotor. Incidentally, an ultrasound test and so on is performed for the turbine rotors manufactured by the above-stated methods.

Hereinafter, it is described that the Nickel-based alloy of the present invention excels in the mechanical strength and the forgeability.

### (Tensile Strength Test and Evaluation of Forgeability)

Here, it is described that the Nickel-based alloy within a chemical composition range of the present invention excels in the mechanical strength and the forgeability. Table 1 shows chemical compositions of a sample 1 to a sample 28 used for a tensile strength test and an evaluation of the forgeability. Incidentally, the sample 1 to the sample 6 are the Nickel-based alloys within the chemical composition range of the present invention, the sample 7 to the sample 28 are the Nickel-based alloys of which compositions are out of the chemical composition range of the present invention, and they are comparative examples. Besides, the sample 7 has a chemical composition equivalent to Inconel 617 being the conventional steel.

TABLE 1

| | | Ni | C | Si | Mn | Cr | Fe |
|---|---|---|---|---|---|---|---|
| EXAMPLE | SAMPLE 1 | REMAINDER | 0.051 | LESS THAN 0.01 | LESS THAN 0.01 | 23.2 | 1.55 |
| | SAMPLE 2 | REMAINDER | 0.049 | LESS THAN 0.01 | LESS THAN 0.01 | 23.38 | 1.58 |
| | SAMPLE 3 | REMAINDER | 0.052 | LESS THAN 0.01 | LESS THAN 0.01 | 22.58 | 1.48 |
| | SAMPLE 4 | REMAINDER | 0.051 | LESS THAN 0.01 | LESS THAN 0.01 | 23.27 | 1.57 |
| | SAMPLE 5 | REMAINDER | 0.050 | LESS THAN 0.01 | LESS THAN 0.01 | 23.40 | 1.59 |
| | SAMPLE 6 | REMAINDER | 0.050 | LESS THAN 0.01 | LESS THAN 0.01 | 23.50 | 1.58 |
| COMPARATIVE | SAMPLE 7 | REMAINDER | 0.098 | 0.51 | 0.55 | 23.14 | 1.51 |
| EXAMPLE | SAMPLE 8 | REMAINDER | 0.095 | LESS THAN 0.01 | LESS THAN 0.01 | 22.43 | 1.46 |
| | SAMPLE 9 | REMAINDER | 0.010 | LESS THAN 0.01 | LESS THAN 0.01 | 22.44 | 1.53 |
| | SAMPLE 10 | REMAINDER | 0.172 | LESS THAN 0.01 | LESS THAN 0.01 | 22.80 | 1.53 |
| | SAMPLE 11 | REMAINDER | 0.096 | LESS THAN 0.01 | LESS THAN 0.01 | 17.85 | 1.44 |
| | SAMPLE 12 | REMAINDER | 0.097 | LESS THAN 0.01 | LESS THAN 0.01 | 28.32 | 1.55 |
| | SAMPLE 13 | REMAINDER | 0.095 | LESS THAN 0.01 | LESS THAN 0.01 | 22.90 | 1.48 |
| | SAMPLE 14 | REMAINDER | 0.099 | LESS THAN 0.01 | LESS THAN 0.01 | 23.11 | 1.55 |
| | SAMPLE 15 | REMAINDER | 0.094 | LESS THAN 0.01 | LESS THAN 0.01 | 22.67 | 1.47 |
| | SAMPLE 16 | REMAINDER | 0.096 | LESS THAN 0.01 | LESS THAN 0.01 | 22.29 | 1.44 |
| | SAMPLE 17 | REMAINDER | 0.097 | LESS THAN 0.01 | LESS THAN 0.01 | 22.78 | 1.55 |
| | SAMPLE 18 | REMAINDER | 0.099 | LESS THAN 0.01 | LESS THAN 0.01 | 23.11 | 1.48 |
| | SAMPLE 19 | REMAINDER | 0.096 | LESS THAN 0.01 | LESS THAN 0.01 | 23.20 | 1.42 |
| | SAMPLE 20 | REMAINDER | 0.095 | LESS THAN 0.01 | LESS THAN 0.01 | 22.42 | 1.49 |
| | SAMPLE 21 | REMAINDER | 0.097 | LESS THAN 0.01 | LESS THAN 0.01 | 22.85 | 1.51 |
| | SAMPLE 22 | REMAINDER | 0.095 | LESS THAN 0.01 | LESS THAN 0.01 | 22.68 | 1.55 |
| | SAMPLE 23 | REMAINDER | 0.099 | LESS THAN 0.01 | LESS THAN 0.01 | 23.20 | 1.55 |
| | SAMPLE 24 | REMAINDER | 0.087 | LESS THAN 0.01 | LESS THAN 0.01 | 22.65 | 1.61 |
| | SAMPLE 25 | REMAINDER | 0.091 | LESS THAN 0.01 | LESS THAN 0.01 | 22.58 | 1.46 |
| | SAMPLE 26 | REMAINDER | 0.088 | LESS THAN 0.01 | LESS THAN 0.01 | 22.69 | 1.53 |
| | SAMPLE 27 | REMAINDER | 0.090 | LESS THAN 0.01 | LESS THAN 0.01 | 22.75 | 1.44 |
| | SAMPLE 28 | REMAINDER | 0.092 | LESS THAN 0.01 | LESS THAN 0.01 | 23.10 | 1.47 |

| | | Al | Mo | Co | Cu | Ti | B | S | Ta | Nb |
|---|---|---|---|---|---|---|---|---|---|---|
| EXAMPLE | SAMPLE 1 | 1.72 | 9.05 | 12.49 | 0.25 | 0.35 | 0.0038 | 0.0012 | 0.11 | 0 |
| | SAMPLE 2 | 1.77 | 9.19 | 12.73 | 0.24 | 0.33 | 0.0031 | 0.0006 | 0.69 | 0 |
| | SAMPLE 3 | 1.75 | 9.2 | 12.28 | 0.24 | 0.32 | 0.0019 | 0.001 | 0 | 0.1 |
| | SAMPLE 4 | 1.77 | 9.21 | 12.73 | 0.24 | 0.34 | 0.0032 | 0.0008 | 0 | 0.37 |
| | SAMPLE 5 | 1.78 | 9.23 | 12.72 | 0.24 | 0.33 | 0.0032 | 0.0005 | Ta + 2Nb = 0.43 | |
| | | | | | | | | | (Ta: 0.1, 2Nb: 0.33) | |
| | SAMPLE 6 | 1.78 | 9.22 | 12.50 | 0.24 | 0.35 | 0.003 | 0.001 | Ta + 2Nb = 0.6 | |
| | | | | | | | | | (Ta: 0.2, 2Nb: 0.4) | |
| COMPARATIVE | SAMPLE 7 | 1.27 | 9.12 | 12.32 | 0.25 | 0.35 | 0.0040 | 0.0009 | 0 | 0 |
| EXAMPLE | SAMPLE 8 | 1.28 | 9.09 | 12.29 | 0.23 | 0.30 | 0.0030 | 0.0008 | 0 | 0 |
| | SAMPLE 9 | 1.24 | 9.15 | 12.23 | 0.23 | 0.33 | 0.0020 | 0.0011 | 0 | 0 |
| | SAMPLE 10 | 1.32 | 9.11 | 12.52 | 0.25 | 0.28 | 0.0032 | 0.0008 | 0 | 0 |
| | SAMPLE 11 | 1.24 | 9.20 | 12.17 | 0.23 | 0.30 | 0.0020 | 0.0013 | 0 | 0 |
| | SAMPLE 12 | 1.23 | 9.15 | 12.33 | 0.24 | 0.35 | 0.0038 | 0.0010 | 0 | 0 |
| | SAMPLE 13 | 1.20 | 7.86 | 12.30 | 0.25 | 0.35 | 0.0035 | 0.0010 | 0 | 0 |
| | SAMPLE 14 | 1.22 | 13.05 | 12.22 | 0.25 | 0.33 | 0.0038 | 0.0012 | 0 | 0 |
| | SAMPLE 15 | 1.25 | 9.19 | 8.90 | 0.24 | 0.30 | 0.0024 | 0.0005 | 0 | 0 |
| | SAMPLE 16 | 1.24 | 8.88 | 16.82 | 0.23 | 0.31 | 0.0031 | 0.0013 | 0 | 0 |
| | SAMPLE 17 | 1.41 | 9.12 | 12.45 | 0.25 | 0.35 | 0.0040 | 0.0010 | 0 | 0 |
| | SAMPLE 18 | 2.24 | 9.18 | 12.38 | 0.25 | 0.33 | 0.0036 | 0.0010 | 0 | 0 |
| | SAMPLE 19 | 1.25 | 9.11 | 12.33 | 0.25 | 0.08 | 0.0038 | 0.0010 | 0 | 0 |
| | SAMPLE 20 | 1.27 | 9.08 | 12.39 | 0.23 | 3.25 | 0.0033 | 0.0090 | 0 | 0 |
| | SAMPLE 21 | 1.33 | 9.00 | 12.35 | 0.25 | 0.31 | 0.0006 | 0.0011 | 0 | 0 |
| | SAMPLE 22 | 1.28 | 9.13 | 12.28 | 0.25 | 0.35 | 0.0072 | 0.0010 | 0 | 0 |
| | SAMPLE 23 | 1.31 | 9.05 | 12.49 | 0.25 | 0.35 | 0.0038 | 0.0012 | 0.08 | 0 |
| | SAMPLE 24 | 1.33 | 9.14 | 12.39 | 0.24 | 0.30 | 0.0041 | 0.0010 | 1.20 | 0 |
| | SAMPLE 25 | 1.26 | 9.20 | 12.28 | 0.04 | 0.32 | 0.0019 | 0.0010 | 0 | 0.06 |
| | SAMPLE 26 | 1.21 | 9.15 | 12.30 | 0.24 | 0.35 | 0.0032 | 0.0010 | 0 | 0.64 |

| | | | | | | | | |
|---|---|---|---|---|---|---|---|---|
| SAMPLE 27 | 1.29 | 9.01 | 12.40 | 0.25 | 0.32 | 0.0031 | 0.0008 | Ta + 2Nb = 0.08 |
| | | | | | | | | (Ta: 0.02, 2Nb: 0.06) |
| SAMPLE 28 | 1.33 | 9.00 | 12.39 | 0.25 | 0.32 | 0.0029 | 0.0008 | Ta + 2Nb = 1.0 |
| | | | | | | | | (Ta: 0.3, 2Nb: 0.7) |

In the tensile strength test, 20 Kg each of the Nickel-based alloys of the sample 1 to the sample 28 having the chemical compositions shown in Table 1 is melted in the vacuum induction melting furnace, made to be an ingot to a steel forging, and a specimen in a predetermined size is manufactured from the steel forging. The tensile strength test is performed based on “JIS (Japanese Industrial Standards) G 0567” (Method of elevated temperature tensile test for steels and heat-resisting alloys) under conditions at the temperatures of 23° C., 700° C. and 800° C. for each sample, and 0.2% proof stress is measured. Here, the temperatures of 700° C. and 800° C. being the temperature conditions in the tensile strength test are set by considering the temperature condition at the normal operation time of the turbine rotor of the steam turbine and the temperature in which a safety factor is counted thereon.

Besides, the evaluations for the forgeability are performed for the respective samples. Here, the forgeability is evaluated by the number of reheat times until a forging ratio becomes three, and presence/absence of a forging crack when the forging ratio becomes three, after performing the forging process until the forging ratio becomes three.

Here, the forging ratio is a ratio in which a cross sectional area of an object to be forged in perpendicular to a direction in which the object to be forged is extended before the forging process is performed is divided by a cross sectional area of the object to be forged in perpendicular to a direction in which the object to be forged is extended after the forging process. Besides, in a general forging process, the forging process is repeated by reheating the object to be forged when the temperature of the object to be forged is lowered, namely when the object to be forged begins to be cured. The number of reheat times is the number of times in which the object to be forged is reheated until the forging ratio is made to be three in the forging process. Besides, the presence/absence of the forging crack is shown by “none” when the object to be forged after the forging process is observed visually and the crack does not exist, and further, the evaluation of the forgeability is shown by “O” to show that the forgeability is excellent. On the other hand, when there is a crack, it is shown by “exist”, and further, the evaluation of the forgeability is shown by “X” to show that the forgeability is inferior.

Table 2 shows measurement results of 0.2% proof stress and evaluation results of the forgeability.

TABLE 2

| | | 0.2% PROOF | | | FORGING EVALUATION (FORGING RATIO = 3) | | |
|---|---|---|---|---|---|---|---|
| | | STRESS, MPa | | | THE NUMBER OF | | |
| | | 23° C. | 700° C. | 800° C. | REHEAT TIMES | FORGING CRACK | FORGEABILITY |
| EXAMPLE | SAMPLE 1 | 428 | 360 | 350 | 10 | NONE | ∘ |
| | SAMPLE 2 | 431 | 381 | 366 | 10 | NONE | ∘ |
| | SAMPLE 3 | 423 | 358 | 330 | 10 | NONE | ∘ |
| | SAMPLE 4 | 425 | 363 | 349 | 10 | NONE | ∘ |
| | SAMPLE 5 | 429 | 374 | 354 | 10 | NONE | ∘ |
| | SAMPLE 6 | 435 | 390 | 368 | 10 | NONE | ∘ |
| COMPARATIVE | SAMPLE 7 | 328 | 254 | 240 | 10 | NONE | ∘ |
| EXAMPLE | SAMPLE 8 | 330 | 265 | 252 | 10 | NONE | ∘ |
| | SAMPLE 9 | 274 | 142 | 130 | 10 | NONE | ∘ |
| | SAMPLE 10 | 353 | 319 | 296 | 15 | EXIST | X |
| | SAMPLE 11 | 334 | 255 | 239 | 10 | NONE | ∘ |
| | SAMPLE 12 | 338 | 261 | 243 | 10 | NONE | ∘ |
| | SAMPLE 13 | 330 | 259 | 248 | 10 | NONE | ∘ |
| | SAMPLE 14 | 340 | 281 | 261 | 12 | EXIST | X |
| | SAMPLE 15 | 335 | 251 | 232 | 10 | NONE | ∘ |
| | SAMPLE 16 | 356 | 280 | 264 | 12 | EXIST | X |
| | SAMPLE 17 | 381 | 288 | 262 | 10 | NONE | ∘ |
| | SAMPLE 18 | 558 | 481 | 355 | 15 | EXIST | X |
| | SAMPLE 19 | 315 | 239 | 228 | 10 | NONE | ∘ |
| | SAMPLE 20 | 465 | 335 | 298 | 12 | EXIST | X |
| | SAMPLE 21 | 331 | 250 | 237 | 10 | NONE | ∘ |
| | SAMPLE 22 | 343 | 256 | 244 | 10 | NONE | ∘ |
| | SAMPLE 23 | 337 | 259 | 248 | 10 | NONE | ∘ |
| | SAMPLE 24 | 349 | 289 | 271 | 10 | EXIST | X |
| | SAMPLE 25 | 333 | 268 | 248 | 10 | NONE | ∘ |
| | SAMPLE 26 | 344 | 277 | 266 | 10 | NONE | ∘ |
| | SAMPLE 27 | 333 | 262 | 247 | 10 | NONE | ∘ |
| | SAMPLE 28 | 345 | 280 | 269 | 10 | NONE | ∘ |

As shown in Table 2, the sample 1 to the sample 6 have high 0.2% proof stresses at respective temperatures, good forgeability, and it turns out that the similar forgeability to the conventional steel having good forgeability can be obtained. The reason why the 0.2% proof stresses become high values is conceivable because a precipitation strengthening and a solid-solution strengthening are realized. On the other hand, for example, it turns out that the 0.2% proof stresses show the high values, but the forgeabilities are not good in the conventional steels such as the sample 18 and the sample 20. As stated above, there is no conventional steel which excels in both the mechanical strength and the forgeability.

### (Greeble Test)

Here, it is described that the Nickel-based alloy within the chemical composition range of the present invention has good hot working property. Incidentally, here, a Greeble test is performed for the respective samples by using the sample 1 to the sample 7 shown in Table 1. Here, the sample 1 to the sample 6 are the Nickel-based alloy within the chemical composition range of the present invention, the sample 7 is the Nickel-based alloy out of the chemical composition range of the present invention (equivalent to Inconel 617), and it is a comparative example.

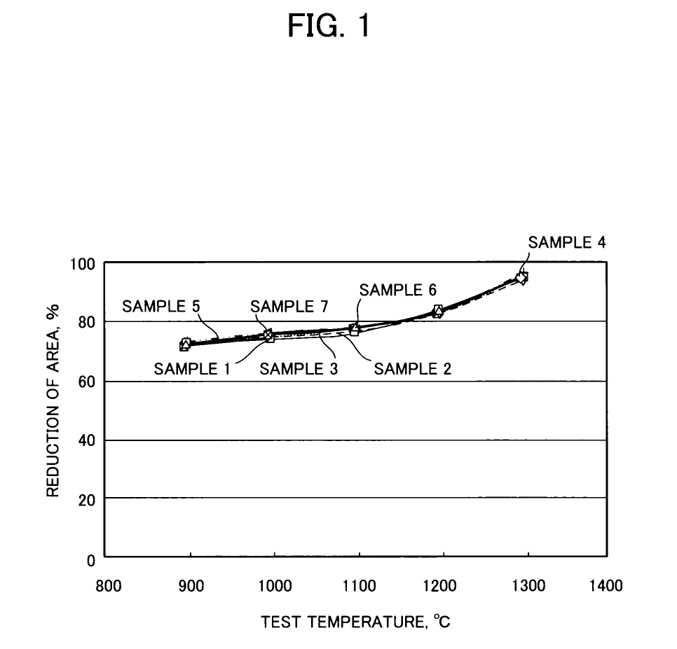

Table 3 shows results of the Greeble test in the above-stated respective samples. Besides, FIG. 1 is a view showing results of the Greeble test in the respective samples shown in Table 3. Here, “reduction of area” shown at a vertical axis in FIG. 1 means a ratio of a cross sectional area decrease from the cross sectional area of the specimen before the test to the cross sectional area of the specimen after the test (after fracture), to the cross sectional area of the specimen before the test. Namely, when the value is large, it means that the sample has a good hot working property.

TABLE 3

| TEST | | | | | | | |
|---|---|---|---|---|---|---|---|
| TEMPERATURE | REDUCTION OF AREA % | | | | | | |
| ° C. | SAMPLE 1 | SAMPLE 2 | SAMPLE 3 | SAMPLE 4 | SAMPLE 5 | SAMPLE 6 | SAMPLE 7 |
| 900 | 73 | 73 | 73 | 73 | 73 | 72 | 70 |
| 1000 | 74 | 75 | 75 | 76 | 76 | 76 | 72 |
| 1100 | 76 | 77 | 78 | 78 | 78 | 78 | 76 |
| 1200 | 84 | 83 | 83 | 84 | 83 | 83 | 81 |
| 1300 | 95 | 94 | 95 | 95 | 96 | 95 | 93 |

As shown in Table 3 and FIG. 1, approximately equal results of the Greeble test can be obtained between the sample 1 to the sample 6 being the Nickel-based alloy within the chemical composition range of the present invention and the sample 7 being the Nickel-based alloy of the conventional steel. Besides, the reduction of area is 70% or more at a temperature range of 900° C. to 1300° C. including a forging temperature range (approximately 950° C. to 1100° C.), and it turns out that the good hot working property is obtained as same as the Nickel-based alloy of the conventional steel.

### (Aging Property)

Here, it is described that the mechanical strength can be maintained even if the Nickel-based alloy within the chemical composition range of the present invention is held at high temperature for a predetermined time.

20 Kg each of the Nickel-based alloys of the sample 1 to the sample 6 having the chemical compositions shown in Table 1 is melted in the vacuum induction melting furnace and is made from an ingot to a steel forging, and a specimen in a predetermined size is manufactured from the steel forging as same as the manufacturing method of the specimen in the above-stated tensile strength test. The tensile strength test is performed based on “JIS (Japanese Industrial Standards) G0567” (Method of elevated temperature tensile test for steels and heat-resisting alloys) under a condition at the temperatures of 700° C. after the manufactured respective specimens are held at 750° C. for 2000 hours, and the 0.2% proof stress is measured. Besides, the tensile strength test under the condition of 700° C. is performed for each specimen before the heat treatment is performed, and the 0.2% proof stress is measured. Here, the reason why the specimen is held at 750° C. is because the maximum usage temperature of the above-stated turbine rotor is considered to obtain safety side data. On the other hand, the temperature of 700° C. being the temperature condition in the tensile strength test is set while considering the temperature condition at the normal operation time of the turbine rotor of the steam turbine.

Table 4 shows measurement results of the 0.2% proof stress in the respective samples.

TABLE 4

| | 0.2% PROOF STRESS, MPa, 700° C. | |
|---|---|---|
| | BEFORE | AFTER BEING HELD AT |
| | HEAT TREATMENT | 750° C. FOR 2000 HOURS |
| SAMPLE 1 | 360 | 330 |
| SAMPLE 2 | 381 | 352 |
| SAMPLE 3 | 358 | 325 |
| SAMPLE 4 | 363 | 344 |
| SAMPLE 5 | 374 | 348 |
| SAMPLE 6 | 390 | 359 |

As shown in Table 4, it turns out that the 0.2% proof stress in the specimen after the heat treatment is a little lowered but the mechanical strength before the heat treatment is approximately maintained. It is therefore conceivable that there is little structure change by time from the above-stated results.

Hereinabove, embodiments of the present invention are described concretely. However, the present invention is not limited to the embodiments, but it is to be understood that all the changes and modifications without departing from the range of the following claims are to be included therein.

What is claimed is:

1. A Nickel-based alloy for a turbine rotor of a steam turbine containing: Carbon: 0.01 to 0.15; Chromium: 18 to 28; Cobalt: 10 to 15; Molybdenum: 8 to 12; Aluminum: 1.5 to 2; Titanium: 0.1 to 0.6; Boron: 0.001 to 0.006; Tantalum: 0.1 to 0.7 in percent by weight, and whose remaining portion is composed of Nickel and unavoidable impurities.

2. A Nickel-based alloy for a turbine rotor of a steam turbine containing: Carbon: 0.01 to 0.15; Chromium: 18 to 28; Cobalt: 10 to 15; Molybdenum: 8 to 12; Aluminum: 1.5 to 2; Titanium: 0.1 to 0.6; Boron: 0.001 to 0.006; Niobium: 0.1 to 0.4 in percent by weight, and whose remaining portion is composed of Nickel and unavoidable impurities.

3. A Nickel-based alloy for a turbine rotor of a steam turbine containing: Carbon: 0.01 to 0.15; Chromium: 18 to 28; Cobalt: 10 to 15; Molybdenum: 8 to 12; Aluminum: 1.5 to 2; Titanium: 0.1 to 0.6; Boron: 0.001 to 0.006; Tantalum+2Niobium: 0.1 to 0.7 in percent by weight, and whose remaining portion is composed of Nickel and unavoidable impurities.

4. The Nickel-based alloy for the turbine rotor of the steam turbine according to claim 1,
wherein Silicon is suppressed to be 0.1 or less and Manganese is suppressed to be 0.1 or less in percent by weight among the unavoidable impurities.

5. The Nickel-based alloy for the turbine rotor of the steam turbine according to claim 2,
wherein Silicon is suppressed to be 0.1 or less and Manganese is suppressed to be 0.1 or less in percent by weight among the unavoidable impurities.

6. The Nickel-based alloy for the turbine rotor of the steam turbine according to claim 3,
wherein Silicon is suppressed to be 0.1 or less and Manganese is suppressed to be 0.1 or less in percent by weight among the unavoidable impurities.

7. A turbine rotor of a steam turbine provided through the steam turbine to which high-temperature steam is inlet,
wherein at least a predetermined portion is constituted by the Nickel-based alloy for the turbine rotor of the steam turbine according to claim 1.

8. A turbine rotor of a steam turbine provided through the steam turbine to which high-temperature steam is inlet, wherein at least a predetermined portion is constituted by the Nickel-based alloy for the turbine rotor of the steam turbine according to claim 2.

9. A turbine rotor of a steam turbine provided through the steam turbine to which high-temperature steam is inlet,
wherein at least a predetermined portion is constituted by the Nickel-based alloy for the turbine rotor of the steam turbine according to claim 3.
